(19) United States
(12) Patent Application Publication
(10) Pub. No.: US 2014/0300826 A1
(43) Pub. Date: Oct. 9, 2014

(54) REAL TIME VIDEO FEED CONFIGURATION FOR REMOTE VISION

(71) Applicant: CATERPILLAR INC., Peoria, IL (US)

(72) Inventors: Brian Funke, Peoria, IL (US); Seth Redenbo, Metamora, IL (US); Daniel Dunn, Dunlap, IL (US); Jason L. Smallenberger, Morton, IL (US)

(73) Assignee: Caterpillar Inc., Peoria, IL (US)

(21) Appl. No.: 13/856,800

(22) Filed: Apr. 4, 2013

(51) Int. Cl. H04N 5/44

(52) U.S. Cl. CPC H04N 5/4403
USPC 348/734

(57) ABSTRACT

A method and system for providing remote vision to a remote operator with respect to one or more machines includes a remote vision system and a wireless transmitter/receiver for communicating with each of the one or more machines. One or more video feeds are available from each machine upon demand. A controller console linked to the remote vision system receives machine data from each of the one or more machines and selects one or more video feeds for display based on the received machine data. The controller console also specifies a resolution for each selected video feed based on the received machine data, such that the transmission of the selected video feeds does not exceed the available bandwidth. The controller console may modify the video selection or resolution specification during operation of the one or more machines based on additional received machine data.

### TECHNICAL FIELD OF THE DISCLOSURE

The present disclosure relates to the remote control and remote monitoring of earth-moving machines and, more particularly, relates to a system and method for adaptively configuring machine video information for display to a remote operator.

### BACKGROUND OF THE DISCLOSURE

Many industrial activities require the use of earth moving machines, material lifting and handling machines, and other large machines. In order to improve operator safety and productivity while reducing operator fatigue, the operation of such machines is increasingly automated and/or executed via remote control (RC). In this way, an operator may monitor and control a machine from the safety and quiet of an operator center rather than spending the work day in the cab of the machine itself.

It is possible for a single operator to monitor multiple remote machines at once via a remote vision system that displays video from each machine to the operator at a remote operator center. Such systems allow for more efficient monitoring due to consolidation of the video feeds in a single location. However, video data is dense and requires high bandwidth for transmission, and so consolidation of all video feeds on one link may decrease available communications bandwidth to the point that some or all signals utilizing that link may become degraded.

While increasing the total bandwidth may offer a solution in rare situations, it is not a feasible solution in most situations due to cost, complexity, or the absence of necessary technology. United States Patent application Pub. No. 2012/0004804, entitled “Apparatus, System and Method Utilizing Aperiodic Nonrandom Triggers for Vehicular Telematics Data Queries” (Beams et al.) describes one attempt to conserve available bandwidth. The system described in the '804 application pertains to the transmission of telematics data, and in an embodiment operates by decreasing or increasing the frequency of update transmissions based on the degree of change sensed by a particular sensor. This is referred to in the '804 application as adjusting the “granularity or resolution” of data points; in the nomenclature of the '804 application then, receiving an update of vehicle speed every 2 seconds represents a higher “granularity or resolution” than receiving such an update only every 4 seconds.

However, in the context of remote machine control, and of remote vision systems for such remote control, machine video feeds tend to require greater bandwidth than the machine data feeds. As such, a tactic of foregoing updates with respect to machine data feeds would not have an impact on reducing overall bandwidth consumption by the transmission of video data.

The present disclosure is directed at least in part to a system that may address the needs discussed or implied above. However, it should be appreciated that the solution of any particular problem is not a limitation on the scope of this disclosure nor of the attached claims except to the extent expressly noted. Additionally, the inclusion of material in this Background section is not an indication that the material represents known prior art other than the application specifically identified above via the application publication number. With respect to such identified prior art, the foregoing characterization is not itself prior art but is simply a brief summary for the sake of reader convenience. The interested reader is referred to the identified publication itself for a more accurate understanding.

### SUMMARY OF THE DISCLOSURE

In accordance with one aspect of the present disclosure, a system is disclosed for providing remote vision to a remote operator with respect to one or more machines. The system includes a remote vision system having one or more display screens and a wireless transmitter/receiver for communicating with each of the one or more machines. The wireless transmitter/receiver is adapted to receive one or more video feeds from each machine upon demand via a wireless channel having an available bandwidth. A controller console linked to the remote vision system is configured to receive machine data from each of the one or more machines and to select one or more video feeds for display based on the received machine data. The controller console also specifies a resolution for each selected video feed based on the received machine data, such that the transmission of the selected video feeds does not exceed the available bandwidth. The controller console may modify the video selection or resolution specification during operation of the one or more machines based on additional received machine data.

In accordance with another aspect of the present disclosure, a method is disclosed for providing remote vision to an operator of a number of machines. The method entails receiving machine data from each of the plurality of machines at an operator center via a wireless link and automatically prioritizing video feeds available from each of the plurality of machines based on the received machine data at a computing device associated with the operator center. The computing device selects video feeds to receive at the operator center and specifies a resolution of each selected video feed based on the prioritization. Instructions are then transmitted to each machine from the operator center instructing each machine to transmit, at the specified resolution, the selected video feeds associated with that machine.

In accordance with yet another aspect of the present disclosure, a non-transitory computer readable medium is provided having thereon computer-executable instructions for providing remote vision to an operator of a plurality of machines. The computer-executable instructions include instructions for receiving machine data from each of the plurality of machines and for automatically prioritizing video feeds available from the machines based on the machine data. The medium further includes instructions for selecting video feeds to receive at the operator center and for specifying a resolution of each such video feed based on the prioritization, as well as instructions for commanding each machine to transmit, at the specified resolution, the selected video feeds associated with that machine.

Other features and advantages of the disclosed systems and principles will become apparent from reading the following detailed disclosure in conjunction with the included drawing figures.

### BRIEF DESCRIPTION OF THE DRAWINGS

FIG. 1 is a schematic diagram of an RC/autonomous machine control and monitoring architecture in accordance with an aspect of the disclosure;

FIG. 2 is a schematic diagram of a machine data and control system in accordance with an aspect of the disclosure;

FIG. 3 is a schematic diagram of a remote operator center architecture in accordance with an aspect of the disclosure;

FIG. 4 is a schematic screen view representation of a display screen in the remote operator center in accordance with an aspect of the disclosure;

FIG. 5 is a flow chart of a process for modifying video feeds and resolutions in accordance with an aspect of the disclosure;

FIG. 6 is a flow chart of a process for selecting video feeds and resolutions in accordance with an aspect of the disclosure;

FIG. 7 is a flow chart of an alternative process for selecting video feeds and resolutions in accordance with an aspect of the disclosure; and

FIG. 8 is a flow chart of a further alternative process for selecting video feeds and resolutions in accordance with an aspect of the disclosure.

### DETAILED DESCRIPTION OF THE DISCLOSURE

The present disclosure provides a system and method applicable to earth-moving machines and other industrial machines used in remote control/monitoring applications such as in mining applications wherein it is desired to provide a remote operator with video information regarding controlled and monitored machines. The system and method further provide adaptive real time video control to allow for efficient usage of available bandwidth. In an embodiment, a controller adjusts video feed parameters based on machine operational parameters such as machine speed, machine location, machine implement operation and machine direction. Adjustments to the video feeds may include, among other adjustments, terminating one or more feeds in favor of one or more other feeds and reducing or increasing the resolution of one or more video feeds relative to one or more other video feeds. As used herein, the term “resolution” refers to the visual resolution of a video image, e.g., in pixels-per-inch or the like.

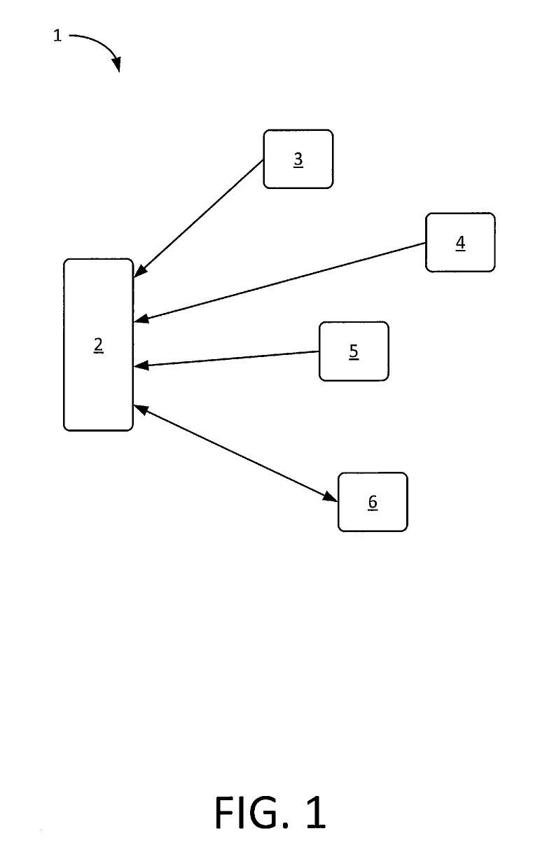

Having given the above overview and referring now more specifically to the drawing figures, FIG. 1 is a schematic diagram of a machine control and monitoring system 1 in accordance with an implementation of the disclosed principles. The illustrated control and monitoring system 1 includes an operator center 2, which is a location from which a human operator may control and/or monitor multiple remote machines. The machines in the illustrated example include a first machine 3, a second machine 4, a third machine 5, and a fourth machine 6.

As will be discussed in detail hereinafter, the operator center 2 includes facilities to allow the operator to view, via video, the operation of one or more of the multiple machines, as well as to control one or more machines. The communication between the operator center 2 and the multiple machines 3, 4, 5, 6 may be unidirectional or bidirectional. For example, when a machine is being remotely controlled by the operator, the communications from the operator center 2 to the machine in question may contain control information, and returning communications may contain status and video information. For machines not currently being controlled, but instead operating in another manner, e.g., autonomously, the machine may provide status and video information to the operator center 2 without receiving control commands.

In an embodiment, the communications between the operator center 2 and a machine are wireless, and may be direct, as in the case of short range wireless communications technology, or may be indirect, as in the case of cellular or other long range communications technologies. In addition, all or some such communications may be encrypted or encoded for security purposes. For example, encryption of remote control commands may prevent unauthorized third parties from controlling a machine in a dangerous or damaging manner.

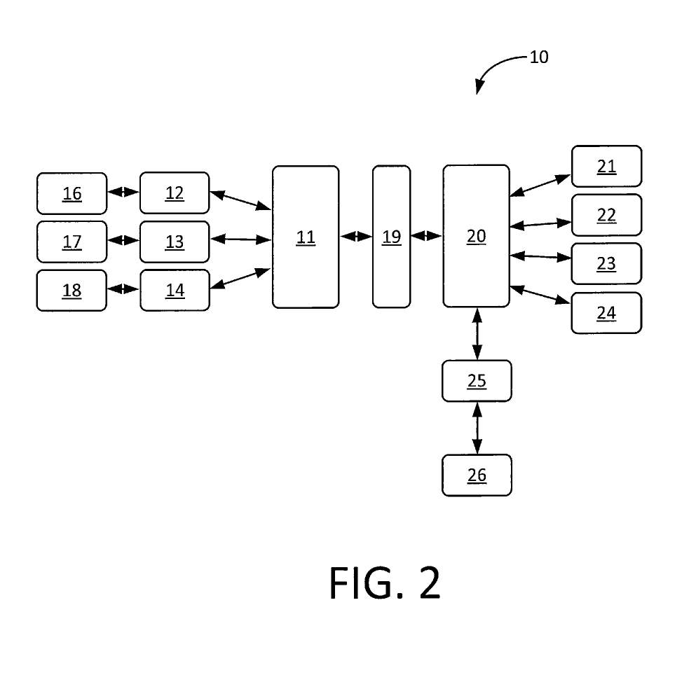

It will be appreciated that in an implementation of the described architecture, the operator center 2 is adapted for control and monitoring of the various machines 3, 4, 5, 6, while the various machines 3, 4, 5, 6 are configured to communicated with and receive control data from the operator center 2. FIG. 2 is a schematic diagram of a machine data and control system 10 in accordance with an implementation of the disclosed principles. The illustrated machine data and control system 10 includes a controller 11 in communication with multiple inputs and outputs to be described. The controller 11 may be any device that controls the receipt and processing of data obtained from the various inputs while also generating commands and/or data for provision to the various outputs.

The controller 11 may be based on integrated circuitry, discrete components, or a combination of the two. In an embodiment, the controller 11 is implemented via a computerized device such as a PC, laptop computer, or integrated machine computer which may be configured to serve the functions of controller 11 as well as numerous other machine functions. In an alternative embodiment, the controller 11 is a dedicated module. In such a case, the controller 11 may be a processor-based device or collection of devices. In an embodiment, the controller 11 is implemented via an electronic control module (ECM).

Regardless of how it is implemented, the controller 11 operates, in an embodiment, by executing computer-executable instructions read from a nontransitory computer-readable medium such as a read only memory, a random access memory, a flash memory, a magnetic disc drive, an optical disc drive, and the like. In addition to these instructions, the data processed by the controller 11 may be read from memory in addition to being obtained from one or more of the various machine inputs. The memory may reside on the same integrated circuit device as the processor of the controller 11 or may alternatively or additionally be located separately from the controller 11.

While the controller 11 and its various inputs and outputs will be described by way of a spoke and hub architecture, it will be appreciated that any suitable bus type may be used. For example, inputs and outputs may be serially multiplexed by time or frequency rather than being provided over separate connections. It will be appreciated that peripheral circuitry such as buffers, latches, switches and so on may be implemented within the controller 11 or separately as desired. Because those of skill in the art will appreciate the usage of such devices, they will not be further described herein.

As noted above, the controller 11 receives a number of inputs or input signals. In the illustrated embodiment, the controller 11 is shown receiving a GPS input 12, a pitch input 13, and a roll input 14. The GPS input 12 may provide location data containing an indication of a current location of the machine. Such data may be derived from a GPS module 16. It will be appreciated that the GPS module 16 may be integrated with the control or data systems of the machine or may be a separate unit.

The pitch input 13 provides data containing an indication of the current pitch angle of the machine, e.g., to assist in identifying critical areas of operation. Pitch angle typically references the angle between a level surface and the machine axis in the direction of travel. By way of example, the data containing the indication of the current pitch angle may be derived from a pitch sensor module 17. The pitch sensor module, which may be integrated with the machine data or control systems or may be a separate module, may measure the pitch of the tracks or other undercarriage of the machine or may measure the pitch of the machine cab. Pitch may be measured via a gravitational sensor or other internal or external means for detecting an amount of divergence from a level attitude.

Similar to the pitch input 13, the roll input 14 provides data indicative of a degree of roll of the machine (roll angle), useable, as with the pitch data, to assist in identifying critical areas of operation. The roll angle typically measures the angle between a level surface and the machine axis perpendicular to the direction of travel, and may be obtained from or derived by a roll sensor module 18. The roll sensor module 18, which may be an integrated or separate component in the same manner as the pitch sensor module 17, may measure the roll angle of the undercarriage or of the cab depending upon the implementation desired. Measurement of the roll angle may be made via a gravitational sensor or other internal or external means as noted above with respect to the measurement of the pitch angle.

In an embodiment, the controller 11 provides a data output to a network gateway 19 such as an Ethernet gateway. The network gateway 19 is responsible for linking the network upon which the controller 11 operates (e.g., a datalink network) to another network upon which a video encoder 20 resides (e.g., an Ethernet network).

The video encoder 20 is in turn linked to a plurality of video cameras including, for example, a first video camera 21, a second video camera 22, a third video camera 23, and a fourth video camera 24. In an embodiment, the video cameras 21, 22, 23, 24 are digital video cameras. In a further embodiment, the first video camera 21 is directed to the front of the machine, to capture video of the terrain toward which the machine is travelling as well as the position of a forward-placed implement or tool, such as a blade. The second video camera 22 is directed to the rear of the machine, to capture video of the terrain, objects, and/or personnel that the machine may travel towards if operated in reverse. The third video camera 23 is directed to the front left of the machine, and the fourth video camera 24 is directed to the front right of the machine.

In an embodiment, rather than the video cameras 21, 22, 23, 24 being linked to the video encoder 20, the video cameras 21, 22, 23, 24 incorporate video encoding functionality. In this alternative embodiment, the video encoder 20 simply serves as a switch or multiplexer.

In order to transmit video and machine data off board to the remote operator center 2, the video encoder 20 is linked to a network encoder 25. The network encoder 25 packages the outgoing data in accordance with the appropriate network protocol, e.g., Ethernet, and similarly unpacks incoming data based on the same protocol. The network encoder 25 communicates wirelessly via a wireless transmitter 26. In an embodiment, the wireless transmitter 26 is a relatively long range transmitter, e.g., capable of communicating with the remote operator center 2 within a range of about 300 meters, but it will be appreciated that technologies with much greater range may be used as well if desired

At the remote operator center 2, an operator center architecture 30 is configured to receive video and machine data from each machine, and to provide the received information to the operator as shown in the schematic diagram of FIG. 2. The operator center architecture 30 is also configured to generate information for transmission to the remote machines, e.g., control commands, video configuration commands, and so on.

In an embodiment, the operator center architecture 30 includes a supplemental server 31, which may include a computing device such as a personal computer, laptop computer, computing console, or other computing device. The supplemental server 31 is responsible, in an embodiment, for generating supplemental content such as e-fencing (virtual machine boundaries) and virtual imagery. The supplemental server 31 may also be used for certain administrative tasks, such as cycle planning and the like, e.g., for coordinating passes with a slot.

The supplemental server 31 is linked to a router or switch 32. The switch 32 serves to link several portions of the operator center architecture 30 together as well as to link these components to the wireless network. Thus, in an embodiment, the switch 32 is also linked to an operator station 33, a vision system 34, and a network encoder 35.

The network encoder 35 of the operator center architecture 30 may be similar to the network encoder 25 of the machine data and control system 10 as described above with respect to FIG. 2. That is, the network encoder 35 of the operator center architecture 30 may package outgoing data in accordance with the appropriate network protocol, e.g., Ethernet, and unpack incoming data based on the same protocol.

The network encoder 35 is linked to, and communicates wirelessly via, a wireless transmitter 36. As with the wireless transmitter 26 of the machine data and control system 10, the wireless transmitter 36 of the operator center architecture 30 may be a relatively long range transmitter capable of communicating with remote machines within a range of about 300 meters, although as noted above, technologies with much greater range may alternatively be used.

The operator station 33 is configured to receive operator inputs and to allow certain program configuration actions such as setting default values and so on. The operator station 33 includes, in an embodiment, one or more operator controls 37. The operator controls 37 may include one or more joystick control systems 38 as well as one or more switches or buttons 39 for braking, acceleration, etc. Each joystick control system 38 may include a plurality of selectable switches, sliders, and/or buttons that may be selected to affect machine operations.

In a further embodiment, the operator station 33 includes a controller console 40. The controller console 40 is a computing device such as a personal computer, laptop computer, computing console, or other computing device. The role of the controller console 40 is to execute instructions or code associated with identifying appropriate video feeds and resolutions and to generate video configuration messages to be sent to one or more of the remote machines.

As noted above, the operator center architecture 30 also includes a vision system 34. In an embodiment, the vision system 34 includes a computing device 41 linked to one or more display screens 42. In an embodiment, the computing device 41 is a computer such as a personal computer. The computing device 41 is configured to convert received video data into a displayable form for use by the one or more display screens 42. In an embodiment, the one or more display screens 42 include a display associated with the computing device 41. Moreover, while the one or more display screens 42 are configured to display material to an operator, the one or more display screens 42 also receive user input via a touch screen mechanism in an embodiment.

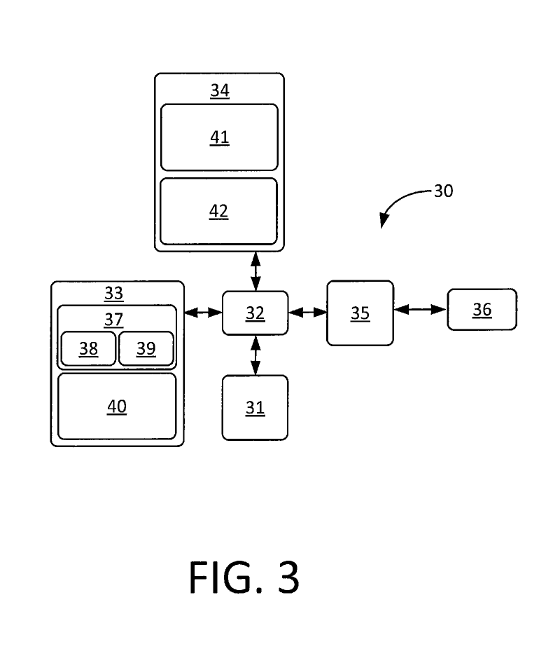

During the remote control or monitoring of one or more machines equipped as discussed above with respect to FIG. 2 via an operator center architecture 30 configured as described with respect to FIG. 3, the computing device 41 drives the one or more display screens 42. In particular, the computing device 41 generates a live video image based on the data received from the onboard video cameras 21, 22, 23, 24.

In an embodiment, in order to preserve available bandwidth on the radio link between the wireless transmitter 26 of the machine data and control system 10 and the wireless transmitter 36 of the operator center architecture 30, the controller console 40 identifies appropriate video feeds and resolutions and generates video configuration messages to be sent to one or more of the remote machines.

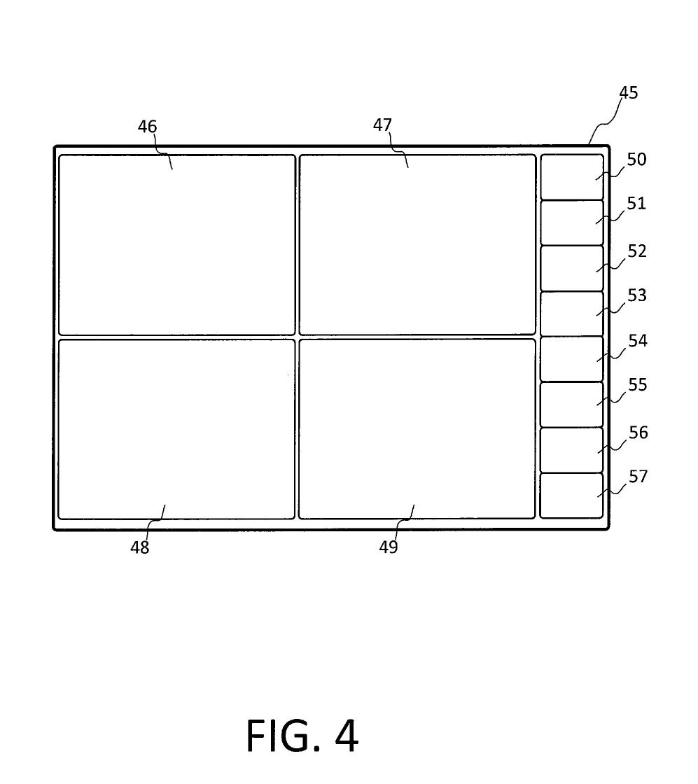

For example, in an implementation shown schematically in FIG. 4, all four video feeds associated with a machine currently being remotely controlled are shown centrally on an operator display 45. In the illustrated example, the four video feeds of the machine being remotely controlled are placed in four adjacent quadrants 46, 47, 48, 49 of the display 45. In addition, selected video feeds, such as direct front or rear views, may be shown for some or all other machines being monitored via miniature displays 50, 51, 52, 53, 54, 55, 56, and 57.

In an embodiment, the controller console 40 determines which video feeds to display centrally in the adjacent quadrants 46, 47, 48, 49 and which video feeds to display in the miniature displays 50, 51, 52, 53, 54, 55, 56, and 57 of the display 45. In addition, in an aspect of the disclosure, the controller console 40 analyzes available bandwidth on the radio link and determines the video feeds required as well as the image resolution of those video feeds in order to avoid exceeding the available bandwidth on the radio link.

With respect to video images, the image resolution may be measured in lines per frame and pixels per line, with a larger number of lines and/or pixels yielding a higher resolution and a lesser number of lines and/or pixels yielding a lower resolution. The determination as to which video feeds to require and the resolution of those feeds may be made based on several different criteria. For example, the controller console 40 may determine an operational mode, location, direction of travel, current task, and machine status for each machine and may make a video feeds/resolutions decision based on one or more of these factors or other factors.

For example, if a particular machine is currently being remotely controlled, the controller console 40 may require all four feeds in normal resolution with respect to that machine. With respect to machines being monitored but not controlled, the controller console 40 may require only a front and rear view video feed for each such machine, and may require only low resolution video for such feeds. By way of another example, machine speed and direction are considered by the controller console 40 in selecting feeds and setting resolution. In keeping with this example, the video feeds for a machine travelling quickly in a forward direction may be required in higher resolution than those for a machine travelling in reverse, at a low speed. These and other aspects of the disclosure will be discussed in greater detail below in connection with the industrial applicability of aspects of the disclosure and embodiments thereof.

### INDUSTRIAL APPLICABILITY

In general terms, the present disclosure sets forth a system and method applicable to earth-moving machines and other industrial machines used in remote control/autonomous control applications such as in mining applications wherein it is desired to provide a remote operator with video information regarding one or more machines being controlled or monitored. The machines to which the operator interfaces via the disclosed system may be of the same or different machine types. In an embodiment, each machine is a dozer, and each dozer is utilized in a mining operation. However, the system may be used in other applications and/or with different machines. Although the system is well-suited to the execution of repetitive tasks, the specific application wherein the system is used need not involve such tasks.

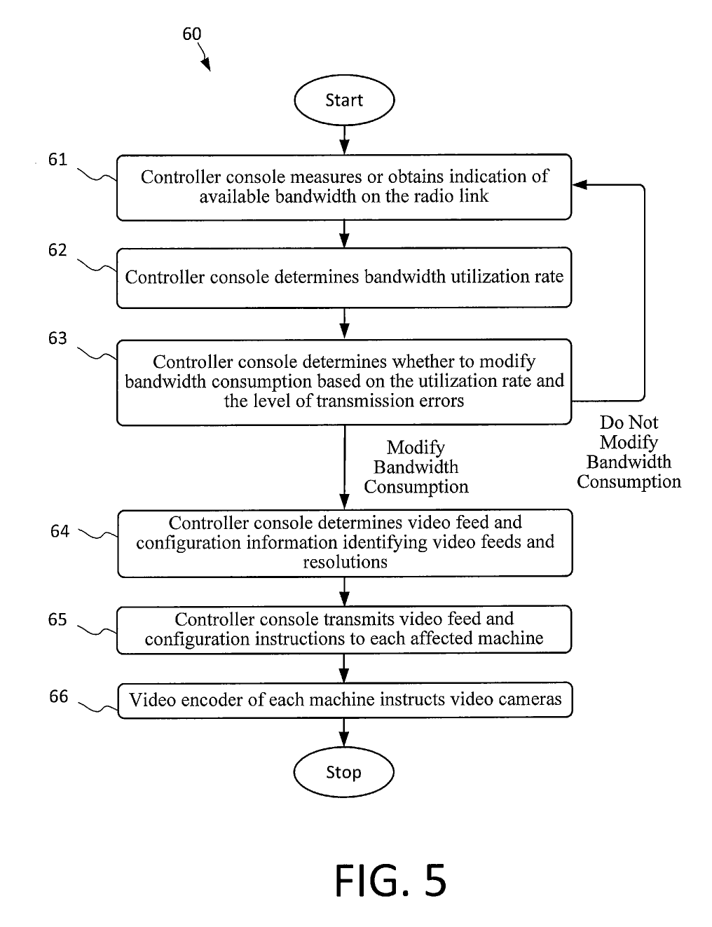

While those of skill in the art will appreciate that there are numerous alternative ways in which to implement the described system and process, an example process flow is illustrated via the flow chart 60 of FIG. 5 with reference to the architectures of FIGS. 1-3 and the display elements of FIG. 4.

The illustrated process describes steps taken at the operator center 2 and at one or more of the remote machines 3, 4, 5, 6. It will be appreciated that certain steps may be executed at the operator center 2 or at one or more of the machines 3, 4, 5, 6, and in some instances a location for such steps will be identified. This is not meant to imply that other steps may not also be executed at one or more machines instead, depending upon implementation preferences, or that a step described as occurring at a machine 3, 4, 5, 6 cannot instead take place at the operator center 2.

Video feed and resolution configuration information is maintained at the operator center 2 in an embodiment, but it will be appreciated that such information may additionally or alternatively be maintained at the relevant machine 3, 4, 5, 6 once generated. Moreover, it will be appreciated that operations taking place at the operator center 2 may be executed via one or both of the supplemental server 31 and controller console 40, and operations taking place at any of the one or more machines 3, 4, 5, 6 may be executed via the controller 11 associated with each such machine or otherwise. The following examples will assume that video feed and resolution configuration information are generated at the operator center 2 by the controller console 40.

In the illustrated embodiment, the process 60 begins at stage 61, wherein the controller console 40 measures or obtains an indication of available bandwidth on the radio link between the operator center 2 and the various machines 3, 4, 5, 6. While this example will assume that the wireless communications to and from all machines are carried on the same channel or frequency, it will be appreciated that alternatively, such communications may take place over separate channels or frequencies.

At stage 62, the controller console 40 determines the bandwidth utilization rate, e.g., the percentage of the available bandwidth that is currently being consumed, and determines the level of transmission errors in the received radio link signal from the machines. At stage 63, the controller console 40 then determines based on the utilization rate and the level of transmission errors whether to modify (e.g., to increase or decrease) bandwidth consumption. If the controller console 40 determines that bandwidth consumption reduction modification is not required, the process 60 returns to stage 61. Otherwise, the process 60 continues to stage 64.

At stage 64, the controller console 40 determines video feed and configuration information identifying which video feeds are to be required and at what resolution. Example processes by which stage 64 may be implemented are described in greater detail later. Having determined the video feed and configuration information, the controller console 40 transmits video feed and configuration instructions, as appropriate, to each machine at stage 65. That is, for each machine that will be required to implement a change in the video feeds that are sent and/or the resolution of video feeds sent by that machine, the controller console 40 transmits the appropriate instructions.

Upon receipt of the video feed and configuration instructions, the video encoder 20 of each machine instructs the relevant video cameras on the machine at stage 66. In particular, specific video cameras may be instructed to produce video at a requested resolution or, if the feed is no longer required at all, to cease sending video information to the video encoder 20 entirely. Alternatively, for feeds that were previously not required but that now are required, the video encoder 20 instructs the relevant video camera to commence sending video information and instructs the camera at what resolution to send the data. From stage 66, the process 60 returns to stage 61.

As noted above, the controller console 40 determines video feed and configuration information identifying which video feeds are to be required and at what resolution. It will be appreciated that there are numerous processes by which this determination may be made, and example processes are discussed below. However, these processes need not be implemented as alternatives. Rather, if desired or needed, criteria and/or steps from each process may be used within another of the processes without limitation.

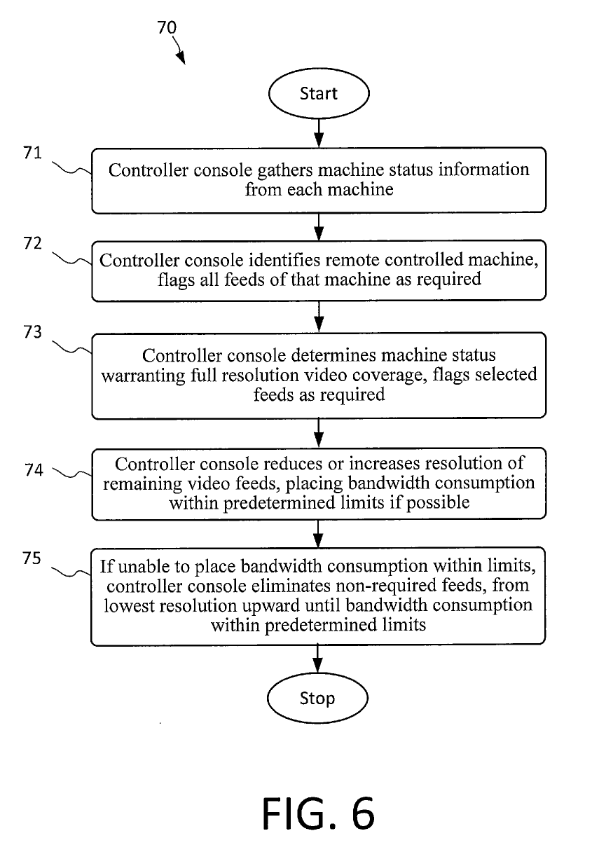

In the example process 70 illustrated in the flow chart of FIG. 6, the determination as to required video feeds and resolutions is made based on machine status information such as machine speed (track speed), engine speed, implement pressure(s), implement position(s), and machine transmission configuration (gear, forward, reverse). At stage 71 of the process 70, the controller console 40 gathers machine status information from each machine, including, for example, but not necessarily limited to, the information identified above.

The controller console 40 then applies a prioritized listing of criteria to the retrieved machine status information to determine required video feeds and resolutions. For example, in the illustrated embodiment, the controller console 40 determines at stage 72 which machine is being remotely controlled, and sets all four video feeds of that machine as required. At stage 73, the controller console 40 determines which autonomously operating machines exhibit a machine speed, engine speed, implement pressure/position, or transmission configuration warranting full resolution video coverage and sets those feeds as required. For example, machines warranting full resolution coverage may be those travelling at or above a threshold speed, having an engine speed at or above a threshold RPM level, having an implement pressure beyond a threshold pressure, having an implement position within a defined range, or having a transmission configuration that is forward and above a defined gear. It will be appreciated that the listed criteria, or other criteria, may be used singly as illustrated or in combination.

At stage 74 of the process 70, the controller console 40 reduces (or increases) the resolution of any remaining video feeds to place overall bandwidth consumption in the link within predetermined limits if possible. At stage 75, if the controller console 40 was unable to place the overall bandwidth consumption within the predetermined limits at stage 74, the controller console 40 then eliminates video feeds, from lowest resolution upward, without eliminating any required feeds, until the overall bandwidth consumption lies within the predetermined limits At that point, the process 70 ends, having made the determination as to which feeds will be used and what the resolutions of those feeds will be.

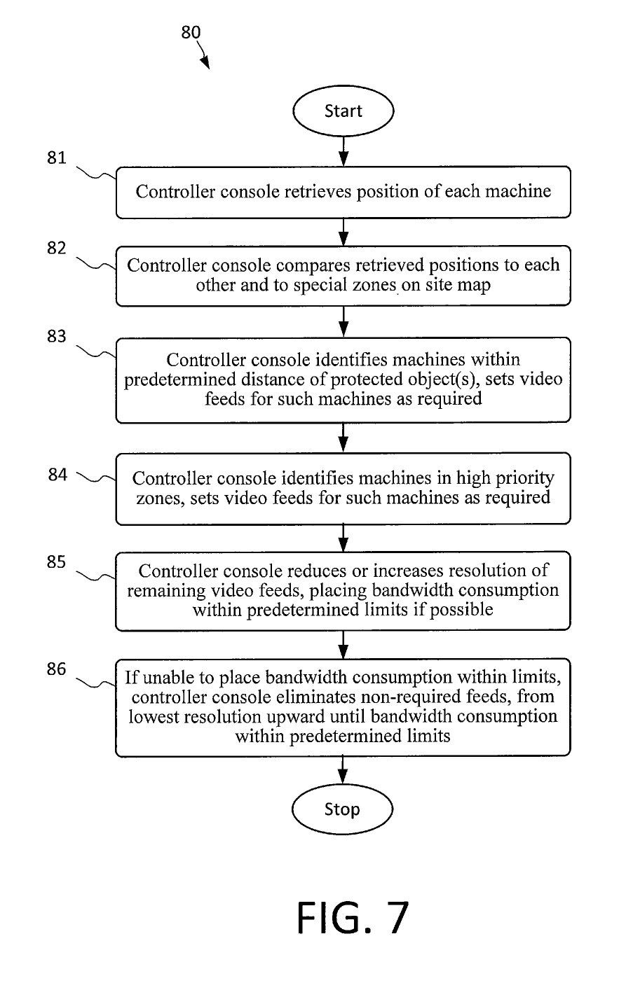

As noted above, different processes may be employed, instead of or in addition to that described above, to determine which feeds will be used and what the resolutions of those feeds will be. In an embodiment, the position of each machine is used to adaptively modify video feeds and resolutions when bandwidth modification is needed. An example process 80 corresponding to this embodiment is shown in FIG. 7.

At stage 81 of the process 80, the controller console 40 retrieves a position of each machine, e.g., as detected by GPS on each machine or otherwise. At stage 82 of the process 80, the controller console 40 compares each retrieved position to each other retrieved position as well as to one or more identified special zones on a map of the site. Subsequently, the determination of required video feeds and resolutions is made based on the above determination. For example, at stage 83, the controller console 40 identifies machines that are within a predetermined distance of another machine, an obstacle, one or more personnel or other protected objects, and sets the video feeds for such machines as required.

At stage 84, the controller console 40 identifies machines that are located within a high priority zone on the map, and sets the video feeds for such machines as required. High priority zones may include crest areas and other areas where increased resolution is warranted. At stage 85 of the process 80, the controller console 40 reduces (or increases) the resolution of any remaining video feeds to place overall bandwidth consumption in the link within predetermined limits if possible. At stage 86, if the controller console 40 was unable to place the overall bandwidth consumption within the predetermined limits, it then eliminates video feeds, from lowest resolution upward, without eliminating any required feeds, until the overall bandwidth consumption lies within the predetermined limits. At that point, the process 80 ends, having determined which feeds will be used and the resolutions of those feeds.

As noted above, machine video feeds and resolutions may also be determined based on machine operation or timing in a cycle. For example, machine operation, as reflected in machine implement positions and pressures, load, and location within a slot may be used to select video feeds and resolutions. In the same way, the placement or timing of a machine within a cycle may be used to set video feeds and resolutions. For example, the video feeds of a machine moving forward under load may be prioritized above the video feeds of a machine moving rearward with a raised blade. With respect to, for example, an excavator, the video feeds of the machine when in the dig to dump portion of a cycle may be prioritized higher than the feeds during the return trip.

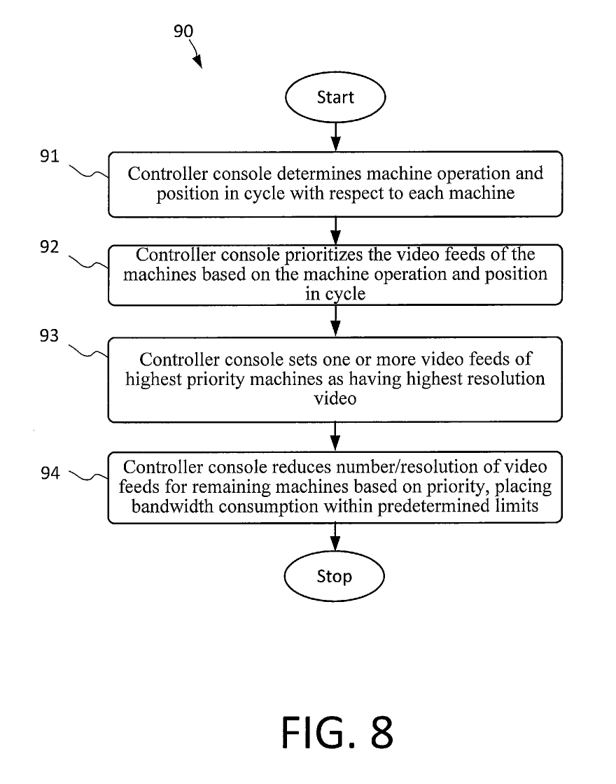

In the example process 90 shown in FIG. 8, the controller console 40 determines the machine operation and position in cycle at stage 91 with respect to each machine. At stage 92, the controller console 40 prioritizes the video feeds of the machines based on the machine operation and position in cycle. Subsequently, the determination of required video feeds and resolutions is made based on the above prioritization. For example, at stage 93, the controller console 40 sets one or more video feeds of the highest priority machines as required and as having the highest resolution video.

The controller console 40 reduces the number or resolution of the video feeds for the remaining machines at stage 94 based on priority, as needed to place overall bandwidth consumption in the link within predetermined limits The manner of following priority for these remaining machines is not important, but an example method is to reduce video resolution starting at the lowest priority until the bandwidth constraints are met. At that point, the process 90 ends, having determined which feeds will be used and the resolutions of those feeds.

It will be appreciated that the present disclosure provides a system and method for facilitating remote operator visualization and control of a machine. While only certain embodiments have been set forth, alternatives and modifications will be apparent from the above description to those skilled in the art. These and other alternatives are considered equivalents and within the spirit and scope of this disclosure and the appended claims.

What is claimed is:

1. A system for providing remote vision to a remote operator with respect to one or more machines, the system comprising:
a remote vision system including one or more display screens;
a wireless transmitter/receiver for communicating with each of the one or more machines, wherein the wireless transmitter/receiver is adapted to receive one or more video feeds from each machine upon demand via a wireless channel having an available bandwidth;
a controller console linked to the remote vision system and configured to receive machine data from each of the one or more machines and select one or more video feeds from at least one of the one or more machines for display on the one or more display screens based on the received machine data, and to specify a resolution for each selected video feed based on the received machine data, such that the transmission of the selected video feeds at the specified resolution requires a first bandwidth that does not exceed the available bandwidth, the controller console being further configured to modify the video selection or resolution specification during operation of the one or more machines based on additional received machine data.

2. The system in accordance with claim 1, wherein the machine data includes a machine location for each of the one or more machines.

3. The system in accordance with claim 2, wherein the controller console is further configured to select the one or more video feeds and specify the resolution for each selected video feed by identifying one or more particular machines that are within a predetermined distance of another machine and enhancing the resolution of any selected video feeds associated with the one or more particular machines.

4. The system in accordance with claim 2, wherein the controller console is further configured to select the one or more video feeds and specify the resolution for each selected video feed by identifying one or more particular machines that are within a predetermined distance of a known obstacle and enhancing the resolution of any selected video feeds associated with the one or more particular machines.

5. The system in accordance with claim 2, wherein the controller console is further configured to select the one or more video feeds and specify the resolution for each selected video feed by identifying one or more particular machines that are within a predetermined priority zone and enhancing the resolution of any selected video feeds associated with the one or more particular machines.

6. The system in accordance with claim 5, wherein the predetermined priority zone includes at least one of a crest region and a slot end region.

7. The system in accordance with claim 1, wherein the machine data includes a machine operation and cycle data for each of the one or more machines.

8. The system in accordance with claim 7, wherein the operation and cycle data includes an identification that one or more particular machines are in a high priority position in a cycle and wherein the controller console is further configured to select the one or more video feeds and specify the resolution for each selected video feed by enhancing the resolution of any selected video feeds associated with the one or more particular machines.

9. The system in accordance with claim 7, wherein the operation and cycle data includes an identification of one or more implement positions and implement pressures associated with each machine, and wherein the controller console is further configured to identify one or more particular machines as high priority based on the implement positions and implement pressures associated with the particular machines, and wherein the controller console is further configured to enhance the resolution of video feeds associated with the one or more particular machines.

10. The system in accordance with claim 7, wherein the operation and cycle data includes an identification of a machine load associated with each machine, and wherein the controller console is further configured to identify one or more particular machines as high priority based on the machine loads associated with the particular machines, and wherein the controller console is further configured to enhance the resolution of video feeds associated with the one or more particular machines.

11. The system in accordance with claim 1, wherein the machine data includes an indication of machine speed and direction for each of the one or more machines.

12. The system in accordance with claim 11, wherein the controller console is further configured to associate identify one or more particular machines as high priority based on the machine speed and direction associated with the particular machines, and wherein the controller console is further configured to enhance the resolution of video feeds associated with the one or more particular machines.

13. A method of providing remote vision to an operator of a plurality of machines, the method comprising:
receiving machine data from each of the plurality of machines at an operator center via a wireless link between the operator center and the plurality of machines;
at a computing device associated with the operator center, automatically prioritizing video feeds available from each of the plurality of machines based on the received machine data;
at the computing device associated with the operator center, selecting video feeds to receive at the operator center from each machine and specifying a resolution of each selected video feed based on the prioritization; and
transmitting instructions to each machine from the operator center via the wireless link instructing each machine to transmit, at the specified resolution, the selected video feeds associated with that machine.

14. The method of providing remote vision in accordance with claim 13, wherein the received machine data includes a machine location for each of the plurality of machines, and wherein automatically prioritizing video feeds available from each of the plurality of machines based on the received machine data includes automatically identifying one or more particular machines that are within a predetermined distance of another machine as having a high priority.

15. The method of providing remote vision in accordance with claim 13, wherein the received machine data includes a machine location for each of the plurality of machines, and wherein automatically prioritizing video feeds available from each of the plurality of machines based on the received machine data includes automatically identifying one or more particular machines that are within a predetermined distance of a known obstacle as having a high priority.

16. The method of providing remote vision in accordance with claim 13, wherein the received machine data includes a machine location for each of the plurality of machines, and wherein automatically prioritizing video feeds available from each of the plurality of machines based on the received machine data includes automatically identifying one or more particular machines that are within a predetermined priority zone.

17. The method of providing remote vision in accordance with claim 13, wherein the received machine data includes an identification of one or more implement positions and implement pressures associated with each machine, and wherein automatically prioritizing video feeds available from each of the plurality of machines based on the received machine data includes automatically identifying the video feeds of one or more particular machines as high priority based on their implement positions and implement pressures.

18. The method of providing remote vision in accordance with claim 13, wherein the received machine data includes an identification of a machine load associated with each machine, and wherein automatically prioritizing video feeds available from each of the plurality of machines based on the received machine data includes automatically identifying the video feeds of one or more particular machines as high priority based on their respective machine loads.

19. The method of providing remote vision in accordance with claim 13, wherein the received machine data includes an indication of machine speed and direction for each of the one or more machines, and wherein automatically prioritizing video feeds available from each of the plurality of machines based on the received machine data includes automatically identifying the video feeds of one or more particular machines as high priority based on their respective machine speeds and directions.

20. A non-transitory computer readable medium having thereon computer-executable instructions for providing remote vision to an operator of a plurality of machines, the computer-executable instructions comprising:
instructions for receiving machine data from each of the plurality of machines at an operator center via a wireless link between the operator center and the plurality of machines;
instructions for automatically prioritizing video feeds available from each of the plurality of machines based on the received machine data;
instructions for selecting video feeds to receive at the operator center from each machine and for specifying a resolution of each selected video feed based on the prioritization; and
instructions for commanding each machine to transmit, at the specified resolution, the selected video feeds associated with that machine.
